(19) United States
(12) Patent Application Publication
(10) Pub. No.: US 2020/0217051 A1
(43) Pub. Date: Jul. 9, 2020

(54) WATER BARREL

(71) Applicant: HOWARD MURRAY, Whittier, CA (US)

(72) Inventor: HOWARD MURRAY, Whittier, CA (US)

(21) Appl. No.: 16/648,565

(22) PCT Filed: Sep. 20, 2018
(86) PCT No.: PCT/US18/52023

§ 371 Date: Mar. 18, 2020

Related U.S. Application Data
(60) Provisional application No. 62/562,263, filed on Sep. 22, 2017.

(51) Int. Cl. E03B 11/06; B29C 41/04

(52) U.S. Cl. CPC E03B 11/06; B29L 2031/712; B29C 41/04

(57) ABSTRACT

Provided herein are systems for pressurized water storage, comprising: a water barrel having at least 3 fittings attached to it, wherein the first fitting is located towards the middle of the water barrel and adapted for sequentially attaching to a pressure gauge and/or valve and a municipal water supply, the second fitting is located towards the bottom of the water barrel and adapted for attaching to a hose bibb valve, and the third fitting is located on the top of the water barrel and adapted for attaching a pressure relief valve. Also provided herein are methods of using the same.

### FIELD OF THE INVENTION

The present disclosure relates to emergency preparedness field, and more particularly to a residential emergency water storage unit.

### BACKGROUND OF THE DISCLOSURE

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Water keeps us alive, is an important part of cooking, and makes up most of the human body. In fact, the human body can last weeks without food, but only a few days without water. Having proper water storage can bring health, safety, and convenience back to life during times of emergency and crisis. Thus there remains a need in the art for new systems and water barrels for preparing consumable water storage in times of emergency and crisis.

### SUMMARY OF THE DISCLOSURE

Various embodiments include a system for pressurized water storage, comprising a water barrel having a first fitting, a second fitting, and a third fitting, wherein the first fitting is located towards the middle of the water barrel and adapted for sequentially attaching to a pressure gauge and/or valve and a municipal water supply, wherein the second fitting is located towards the bottom of the water barrel and adapted for attaching to a hose bibb valve, and wherein the third fitting is located on the top of the water barrel and adapted for attaching a pressure relief valve. In another embodiment, the municipal water supply is a household municipal water supply. In another embodiment, the hose bibb valve is adapted for use as a source of outside water such as watering plants and/or washing a car. In another embodiment, the water barrel is molded by rotational molding. In another embodiment, the water barrel is rotationally molded with Marlex 935 and/or 945 resin. In another embodiment, the water barrel is a dual layer barrel comprising an inner layer and an outer layer. In another embodiment, the inner layer of the water barrel is substantially made of FDA approved water consumption plastic. In another embodiment, the outer layer of the water barrel is substantially made of plastic having UV protection. In another embodiment, the circulation of municipality water supply preserves its drinkability. In another embodiment, the system further comprises a removable bottom tray and/or a removable top tray. In another embodiment, the first and second fittings are ½″ water bibbs. In another embodiment, the third fitting is a ¾″ pressure relief valve. In another embodiment, the pressure reducer gauge is a 20 lb pressure reducer gauge.

Other embodiments include a process for manufacturing a leak free under pressure water storage, comprising prepare a plastic container able to withstand water pressure using a rotational molded mixture process, and attach one or more leak free fittings to the plastic container. In another embodiment, the plastic container can withstand water pressure of up to 25 lbs. In another embodiment, the plastic container can withstand water pressure of up to 35 lbs. In another embodiment, the plastic container can withstand water pressure of up to 50 lbs. In another embodiment, the one or more leak free fittings are brass. In another embodiment, the one or more leak free fittings are lead free. In another embodiment, the one or more leak free fittings include ½ inch and ¾ inch brass inserts, and a female tapered pipe threaded with a doublehex end. In another embodiment, a ½ inch or ¾ inch tapered threaded ⅛ inch wide brass nut is installed onto a water valve. In another embodiment, the water valve is a ½ inch spigot or ball valve, or a ¾″ pressure reducer. In another embodiment, the plastic container comprises at least 3 fittings attached to it. In another embodiment, the at least 3 fittings comprise a first fitting located towards the middle of the plastic container and adapted for sequentially attaching to a pressure gauge and/or valve and a municipal water supply, a second fitting located towards the bottom of the plastic container and adapted for attaching to a hose bibb valve, and a third fitting located on the top of the plastic container and adapted for attaching a pressure relief valve.

Other embodiments include a container for pressurized water storage, comprising providing a pressurized plastic container having a first fitting, a second fitting, and/or a third fitting, wherein the first fitting is located near the middle of the pressurized plastic container, wherein the second fitting is located near the bottom of the pressurized plastic container, and wherein the third fitting is located near the top of the pressurized plastic container. In another embodiment, the first, second and third fitting is leak free. In another embodiment, the first, second and third fitting is lead free. In another embodiment, the first fitting is adapted for attaching to a pressure gauge and/or valve and a municipal water supply. In another embodiment, the second fitting is adapted for attaching to a hose bibb valve. In another embodiment, the third fitting is adapted for attaching a pressure relief valve. In another embodiment, the pressurized plastic container is rotationally molded with Marlex 935 and/or 945 resin. In another embodiment, the container can withstand water pressure of up to 25 lbs.

Other features and advantages of the invention will become apparent from the following detailed description, taken in conjunction with the accompanying drawings, which illustrate, by way of example, various embodiments of the invention.

### DESCRIPTION OF THE DRAWINGS

Exemplary embodiments are illustrated in referenced figures. It is intended that the embodiments and figures disclosed herein are to be considered illustrative rather than restrictive.

FIG. 1 illustrates a perspective view of the water barrel in accordance with an embodiment of the disclosure.

FIG. 2 illustrates a perspective view of another water barrel in accordance with an embodiment of the disclosure.

FIG. 3 illustrates a perspective view of another water barrel in accordance with an embodiment of the disclosure.

FIG. 4 illustrates a top view of the water barrel in accordance with an embodiment of the disclosure.

FIG. 5 illustrates a perspective view of another water barrel in accordance with an embodiment of the disclosure.

FIG. 6 illustrates a cross sectional drawing of the water barrel with the two layer wall.

### DETAILED DESCRIPTION

All references, publications, and patents cited herein are incorporated by reference in their entirety as though they are fully set forth. Unless defined otherwise, technical and scientific terms used herein have the same meaning as commonly understood by one of ordinary skill in the art to which this invention belongs. One skilled in the art will recognize many methods and materials similar or equivalent to those described herein, which could be used in the practice of the present invention. Indeed, the present invention is in no way limited to the methods and materials described.

The term “plastic” as used herein refers to a range of synthetic or semi-synthetic solid materials, such as homo- or hetero-co-polymers of organic building blocks (monomer) with a functionalized surface such that organic molecules can be attached through covalent bond formation or absorbed through electronic or static interactions such as through bond formation through a functional group. Preferably the term “plastic” refers to polyolefin, which is a polymer derived by polymerization of an olefin (e.g., polyethylene).

As disclosed herein, in accordance with the various embodiments herein, the inventor has developed a novel residential emergency water storage unit that never needs refilling. The water barrel disclosed herein is an in-line water pressurized and circulated water barrel, which stores water for emergency purposes with a small footprint and reasonable costs.

In one embodiment, disclosed herein is a system for pressurized water storage, comprising: a water barrel 100 having at least three fittings attached to it, wherein the first fitting 106 is located towards the middle of the water barrel 100 and adapted for sequentially attaching to (a) a pressure gauge and/or valve 110 and (b) a municipal water supply 102, the second fitting 104 is located towards the bottom of the water barrel 100 and adapted for attaching to a hose bibb valve, and the third fitting 108 is located on the top of the water barrel and adapted for attaching a pressure relief valve. In one embodiment, the hose bibb valve on the second fitting 104 is adapted for use as an emergency or non-emergency source of outside water, such as watering plants or washing a car. In one embodiment, the water barrel 100 is molded by rotational molding. In one embodiment, the water barrel 100 is rotationally molded with either Marlex 935 and/or 945 resin. In one embodiment, the water barrel 100 is a dual layer wall barrel comprising an inner layer of wall 302 and an outer layer of wall 304. In one embodiment, the inner layer of wall 302 of the water barrel 100 is substantially made of FDA approved water consumption plastic. In one embodiment, the outer layer of wall 304 of the water barrel 100 is substantially made of plastic having UV protection. In one embodiment, the circulation of municipality water supply preserves its drinkability. In one embodiment, the water barrel 100 further comprises a removable bottom tray 202 and/or a removable top tray 204. In one embodiment, the first 106 and second fittings 104 are ½″ water bibbs. In one embodiment, the third fitting 108 is a ¾″ pressure relief valve. In one embodiment, the pressure reducer gauge is a 20 lb pressure reducer gauge.

In one embodiment, disclosed herein is a method of pressurized water storage, comprising: providing a water barrel 100 having at least 3 fittings attached to it, wherein the first fitting 106 is located towards the middle of the water barrel 100 and adapted for sequentially attaching to (a) a pressure gauge and/or valve 110 and (b) a municipal water supply 102, the second fitting 104 is located towards the bottom of the water barrel 100 and adapted for attaching to a hose bibb valve, and the third fitting 108 is located on the top of the water barrel and adapted for attaching a pressure relief valve; and storing pressurized water using the water barrel.

As further disclosed herein, an advantage of various embodiments of the water barrel developed by the inventor is its ability to hold water under pressure. Few if any other plastic products in this industry are able to pressurize plastic. In accordance with various embodiment herein, it's design along with a plastics mixture manufacturing process (rotational molded) and leak free fittings all work in conjunction to keep the barrels water under pressure (25 lbs). This was accomplished in part due to leak free brass inserts and nuts. In one embodiment, the present invention provides a plastics mixture water barrel designed to be able to hold water under pressure and be leak free. In another embodiment, the plastics mixture water barrel further includes leak free brass inserts and nuts. In another embodiment, the inserts and/or nuts are lead free.

In another embodiment, the barrel manufacturing process includes one or more of the following: include lead free (0.25 or below of lead content) ½″ & ¾″ brass inserts, female tapered pipe threaded, with a doublehex end to keep the insert from spinning along with the rounded opposite end, to allow for a EDPM washer to seal the fitting edge that meets the plastic; a ½″ or ¾″ tapered threaded ⅛″ wide brass nut is installed onto the water valve, be it a ½″ spigot or ball valve, or a ¾″ pressure reducer, before its installation; the sealant tape is then installed, followed by the EDPM washer; the valve is then inserted and tightened down into the brass fitting on the exterior of the barrel; the brass nut is then tightened down onto the EDPM washer; the barrel is then filled with 25 lbs of air and checked for leaks with a soapy water mixture; if one of the fitting shows bubbles, one is able to tighten down on the nuts to stop the leak.

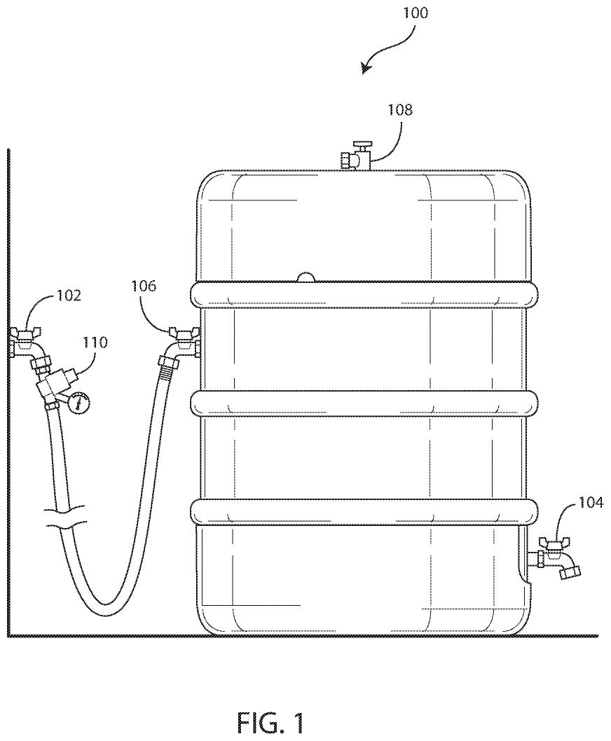

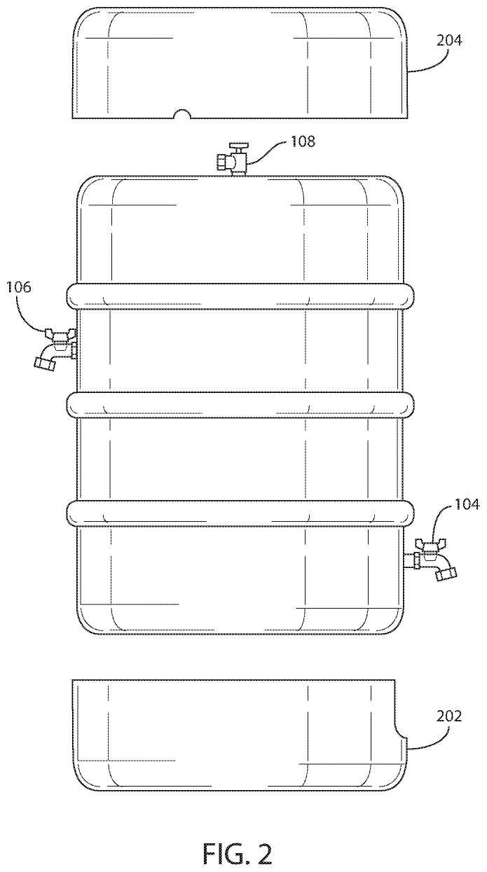

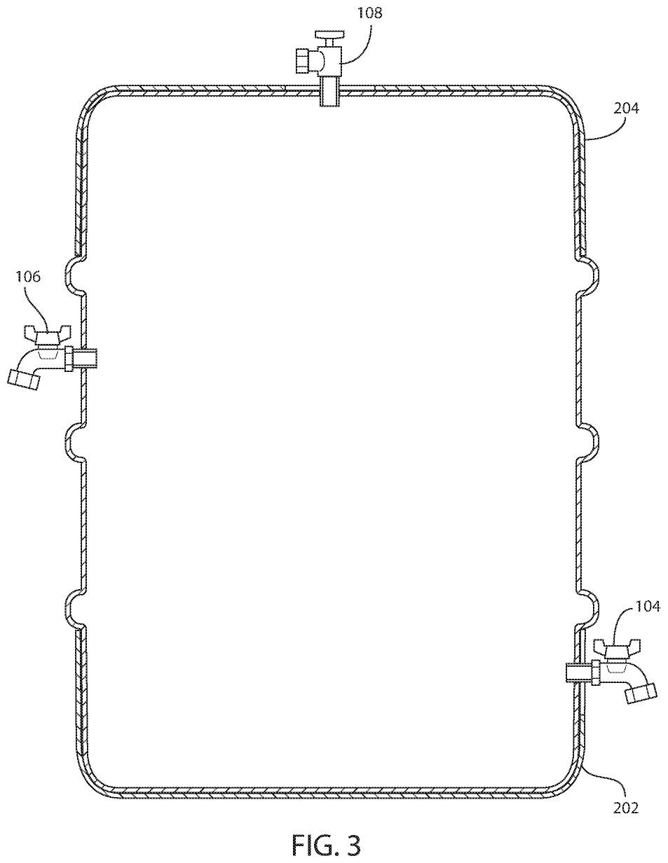

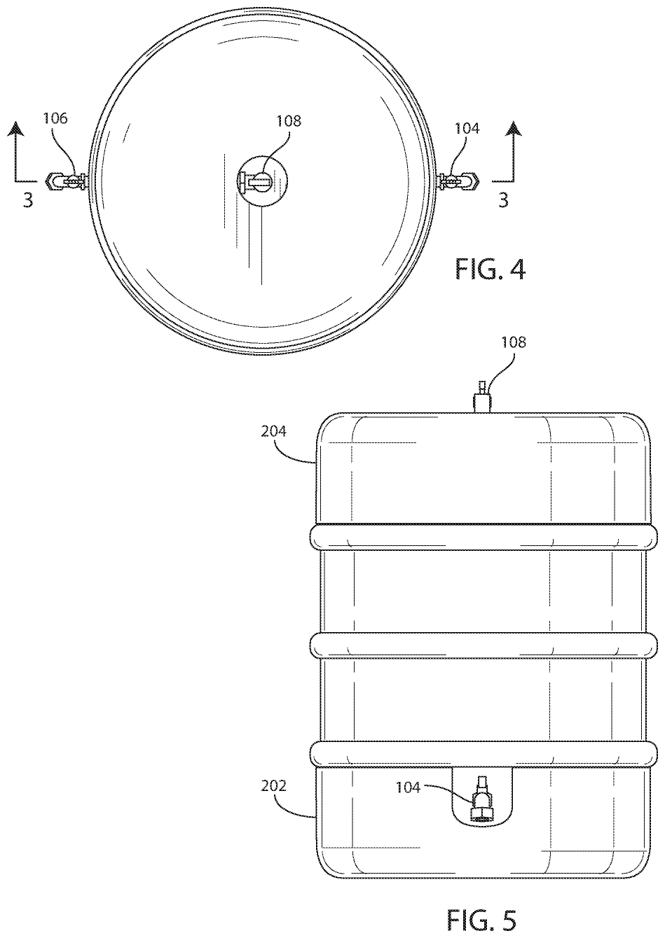

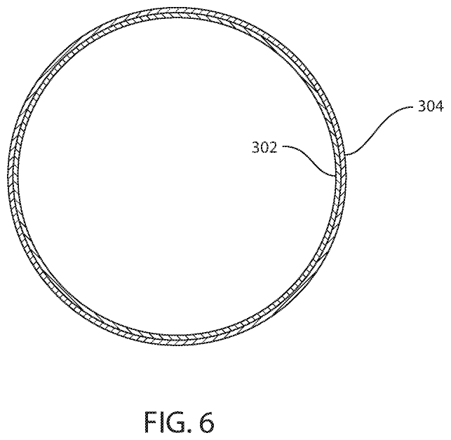

Referring now to the drawings, wherein the drawings are for purposes of illustrating embodiments of the present disclosure only, and not for the purposes of limiting the same, FIGS. 1-6 provide various embodiments and views of the water barrel 100 in accordance with embodiments of the disclosure.

In one embodiment, the water barrel 100 is a single or two layer rotational molded emergency water barrel that will be connected to the residential homes outside water bibb and/or municipal water supply 102 and is then used as the homes water source for outside use, i.e. non-emergency watering the plants or washing a car. The circulation of the municipalities' certified drinking water preserves its drinkability of the water. It is a single or two layer rotational molded, barrel water storage unit. It has three fittings attached to it; two are ½″ water bibs, located on the side of the barrel, one towards the bottom and one at the middle of the barrel. The third fitting 108 is at the top of the barrel, which is for the ¾″ pressure relief valve. A bottom tray 202 and top tray 204 is utilized for ground placement and hose storage. The homes water hose and/or municipal water supply 102 will be disconnect, then the provided 20 lb pressure reducer gauge/valve 110 will be installed on that bibb. A provided 10′ double female water hose will be hooked from the homes water source bibb to the barrels upper ½″ bibb. The top pressure relief valve on the third fitting 108 will then be opened. Once the barrel is filled, the pressure relief valve will be closed. The barrel would be full and the water source bibb would stay open as long as the barrel is attached to it. The Barrel's lower bibb would replace the home's current bibb and/or municipal water supply 102 as the new source of the outside water. Thus, about 30-gallons of city certified water would be available in case of emergencies. 30-gallons of water is enough to sustain a family of four for one week. In some embodiments, if 30-gallons are not enough, one may daisy chain additional barrels to the first one and increase water storage to 60-gallons, 90-gallons and so on. The Barrel's foot print has purposely been designed small, and for those homes with tank less water heaters, the barrel will be essential for water storage.

In one embodiment, the water barrel 100 is a single or dual wall barrel that is rotationally molded with either Marlex 935 or 945 resin, or similar polymers. If non FDA polymers are used due to the color choice of the outer layer of wall 304, a layer of FDA polymer will be applied to the inner layer of wall 302 for the barrel to have potable water and FDA approval. Thus, in some embodiments contemplated herein, the water barrel 100 may have another layer of FDA approved water consumption polymer or resin. In one embodiment, the inner layer of wall 302 of the water barrel 100 is made of FDA approved water consumption plastic. This layer would not be directly exposed to harmful direct sun light. An outer layer of wall 304, with UV protection would be the barrier between harmful rays and exposed exterior abuse.

In one embodiment, rotational molding is used for making the water barrel 100. In one embodiment, the use of rotational molding is important to the structural integrity of the barrel. Rotational Molding (BrE moulding) involves a heated hollow mold which is filled with a charge or shot weight of material. It is then slowly rotated (usually around two perpendicular axes), causing the softened material to disperse and stick to the walls of the mold. In order to maintain even thickness throughout the part, the mold continues to rotate at all times during the heating phase and to avoid sagging or deformation also during the cooling phase.

In one embodiment, the water barrel 100 may further comprise a logo or instructions for using. In one embodiment, the logo or instructions may be added to the surface of the water-barrel 100, and the logo or instructions may be applied during the molding process. In one embodiment Mold in Graphics (MIG) is used to apply the logo or instructions to the water barrel 100. MIG are a durable graphic that gets applied to the products. It is a printed sheet, with a logo and/or instructions for the product or it may just be a design. In one embodiment, this is added as part of the manufacturing process, during the molding process.

### EXAMPLES

### Example 1

### Challenges

There were several obstacles that the inventor faced in developing the various embodiments of the water barrel described herein. For example, a significant challenge was that water stored must be drinkable and that therefore all relevant parts must be lead-free, often FDA approved, to ensure that all water stored is safe for human consumption. Further, the inventor had to overcome the general widely held belief in the field that one cannot pressurize a plastic barrel. The common belief was that a pressurized plastic barrel would have substantial challenges as it just won't hold water pressure on top of the weight of the water. In accordance with various embodiments herein, when the barrel is manufactured through the process of rotational molding, lead-free brass inserts are placed at the opening locations on the mold. At the completion, the female fitting are encased in the plastic barrel. One can then install the male, water faucet or male pressure reducer, into the fitting (insert). But, industry standard inserts will not work, as they are unable to stop the leakage. Custom brass inserts and nuts developed by the inventor were an important part of how the inventor was able to overcome these challenges, and create a plastic barrel that could actually hold the necessary water pressure.

### Example 2

### Brass Inserts—Overcoming Leaking Challenges

An initial challenge was that there was water leakage in early versions of the water barrel. Inserts fitted for O Rings still resulted in water leakage. As part of efforts to overcome this issue, the inventor made the insert with one hex at the rear of the part, about half the length of the part wide, and made the front round with the diameter of what the groove would be, in order to enable the washer to be of smaller diameter and the joint between the plastic and metal to be round with less area to leak vs the hex. The faucets/relief valve was pipe thread, using a straight thread nut approximately ⅛″ thick of the corresponding hex size. The inventor also determined that keeping taper threads would prevent water flow down the thread itself, and that with both the part and insert tapered, it was possible to get a better seal. In accordance with various embodiments herein, the inventor developed a custom designed insert along with the nut and washer. In one embodiment, the insert is rounded at one end, a nut that fits to the standard water spigot, used with a EDPM washer, with both the inserts and nuts have tapered threads. The inventor then tested under air pressure, spraying soapy water on the fittings to check for leaks, with a result of no water leakage.

### Example 3

### Coloring of the Barrel—Developing a Plastic Colorant FDA Approved Mixture that Would Blend Well with a Marlex HMN TR-945G Main Plastic Mixture

In accordance with various embodiments herein, the inventor had to develop a specific colorant mixture that was both FDA approved, and would blend satisfactorily with the main plastic mixture. In accordance with various embodiments herein, the five below colors were successfully mixed, with mixtures to 11.5 lbs-13 lbs. Colors from Spectra, and must contain FDA ingredients for drinking water. They are for the barrel of Marlex HMN TR-945G, which does not have a high gloss finish.

D1803134-PE 3-2 Green

D1803131-PE 3-4 Light Blue

D1703233-PE 4-5 Light Brown

D1803133-PE 3-2 Red

D1803132-PE 3-4 Cool Gray

### Example 4

### Developing a Spinweld for the Barrel

In accordance with various embodiments herein, the inventor developed a custom spinweld. In one embodiment, the brass inserts are molded into a plastic casing that then get driven into the top hole of the barrel, which is permanent and leak proof. In another embodiment, the spinweld is eliminated altogether in the mold.

### Example 5

### Leak Free Brass Inserts and Nuts

An objective of the waterfull barrel, and one of the reasons why it stands out from other products, is because of its ability to hold water under pressure. It's design along with its plastics mixture manufacturing process (rotational molded) and its leak free fittings all work in conjunction to keep the barrels water under pressure (25 lbs). The lead free (0.25 or below of lead content) ½″ & ¾″ brass inserts, female tapered pipe threaded, with a doublehex end to keep the insert from spinning along with the rounded opposite end, to allow for a EDPM washer to seal the fitting edge that meets the plastic. A ½″ or ¾″ tapered threaded ⅛″ wide brass nut is installed onto the water valve, be it a ½″ spigot or ball valve, or a ¾″ pressure reducer, before its installation. The sealant tape is then installed, followed by the EDPM washer. The valve is then inserted and tightened down into the brass fitting on the exterior of the barrel.

The brass nut is then tightened down onto the EDPM washer. The barrel is then filled with 25 lbs of air and checked for leaks with a soapy water mixture. If one of the fitting shows bubbles, this is key, one is able to tighten down on the nuts to stop the leak. Few if any other plastic products in this industry are able to pressurize plastic.

The various methods and techniques described above provide a number of ways to carry out the invention. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps, some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art.

In some embodiments, the numbers expressing quantities, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a,” “an,” and “the” and similar references used in the context of describing a particular embodiment of the invention (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Preferred embodiments of this invention are described herein, including the best mode known to the inventors for carrying out the invention. Variations on those preferred embodiments will become apparent to those of ordinary skill in the art upon reading the foregoing description. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above cited references and printed publications are herein individually incorporated by reference in their entirety.

In closing, it is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

What is claimed is:

1. A system for pressurized water storage, comprising:
a water barrel having a first fitting, a second fitting, and a third fitting,
wherein the first fitting is located towards the middle of the water barrel and adapted for sequentially attaching to a pressure gauge and/or valve and a municipal water supply,
wherein the second fitting is located towards the bottom of the water barrel and adapted for attaching to a hose bibb valve, and
wherein the third fitting is located on the top of the water barrel and adapted for attaching a pressure relief valve.

2. The system of claim 1, wherein the municipal water supply is a household municipal water supply.

3. The system of claim 1, wherein the hose bibb valve is adapted for use as a source of outside water such as watering plants and/or washing a car.

4. The system of claim 1, wherein the water barrel is molded by rotational molding.

5. The system of claim 1, wherein the water barrel is rotationally molded with Marlex 935 and/or 945 resin.

6. The system of claim 1, wherein the water barrel is a dual layer barrel comprising an inner layer and an outer layer.

7. The system of claim 6, wherein the inner layer of the water barrel is substantially made of FDA approved water consumption plastic.

8. The system of claim 6, wherein the outer layer of the water barrel is substantially made of plastic having UV protection.

9. The system of claim 1, wherein the circulation of municipality water supply preserves its drinkability.

10. The system of claim 1, further comprising a removable bottom tray and/or a removable top tray.

11. The system of claim 1, wherein the first and second fittings are ½″ water bibbs.

12. The system of claim 1, wherein the third fitting is a ¾″ pressure relief valve.

13. The system of claim 1, wherein the pressure reducer gauge is a 20 lb pressure reducer gauge.

14. A process for manufacturing a leak free under pressure water storage, comprising:
prepare a plastic container able to withstand water pressure using a rotational molded mixture process; and
attach one or more leak free fittings to the plastic container.

15. The process of claim 14, wherein the plastic container can withstand water pressure of up to 25 lbs.

16. The process of claim 14, wherein the plastic container can withstand water pressure of up to 35 lbs.

17. The process of claim 14, wherein the plastic container can withstand water pressure of up to 50 lbs.

18. The process of claim 14, wherein the one or more leak free fittings are brass.

19. The process of claim 14, wherein the one or more leak free fittings are lead free.

20. The process of claim 14, wherein the one or more leak free fittings include ½ inch and ¾ inch brass inserts, and a female tapered pipe threaded with a doublehex end.

21. The process of claim 14, wherein a ½ inch or ¾ inch tapered threaded ⅛ inch wide brass nut is installed onto a water valve.

22. The process of claim 21, wherein the water valve is a ½ inch spigot or ball valve, or a ¾″ pressure reducer.

23. The process of claim 14, wherein the plastic container comprises at least 3 fittings attached to it.

24. The process of claim 23, wherein the at least 3 fittings comprise a first fitting located towards the middle of the plastic container and adapted for sequentially attaching to a pressure gauge and/or valve and a municipal water supply, a second fitting located towards the bottom of the plastic container and adapted for attaching to a hose bibb valve, and a third fitting located on the top of the plastic container and adapted for attaching a pressure relief valve.

25. A container for pressurized water storage, comprising:
providing a pressurized plastic container having a first fitting, a second fitting, and/or a third fitting,
wherein the first fitting is located near the middle of the pressurized plastic container,
wherein the second fitting is located near the bottom of the pressurized plastic container, and
wherein the third fitting is located near the top of the pressurized plastic container.

26. The container of claim 25, wherein the first, second and third fitting is leak free.

27. The container of claim 25, wherein the first, second and third fitting is lead free.

28. The container of claim 25, wherein the first fitting is adapted for attaching to a pressure gauge and/or valve and a municipal water supply.

29. The container of claim 25, wherein the second fitting is adapted for attaching to a hose bibb valve.

30. The container of claim 25, wherein the third fitting is adapted for attaching a pressure relief valve.

31. The container of claim 25, wherein the pressurized plastic container is rotationally molded with Marlex 935 and/or 945 resin.

32. The container of claim 25, wherein the container can withstand water pressure of up to 25 lbs.
